(19) United States
(12) Patent Application Publication
(10) Pub. No.: US 2019/0010570 A1
(43) Pub. Date: Jan. 10, 2019

(54) METHOD OF MANUFACTURING PRESS FORMED PRODUCT

(71) Applicant: TOA Industries Co., Ltd., Ota-shi (JP)

(72) Inventors: Yasutaka SUZUKI, Ota-shi (JP); Tadashi IWANUMA, Isesaki-shi (JP); Ken-ichiro MORI, Takarazuka-shi (JP); Yuki NAKAGAWA, Toyohashi-shi (JP)

(73) Assignee: TOA Industries Co., Ltd., Ota-shi (JP)

(21) Appl. No.: 16/014,432

(22) Filed: Jun. 21, 2018

(30) Foreign Application Priority Data
Jul. 4, 2017 (JP) 2017-131343

(51) Int. Cl. C21D 9/46; C22F 1/043; B21D 22/02; B23K 26/26

(52) U.S. Cl. CPC C21D 9/46; C22F 1/043; B23K 2103/10; B23K 26/26; C21D 2211/001; B21D 22/022

(57) ABSTRACT

The invention provides manufacturing a partially reinforced press formed product with high corrosion resistance and weldability. First and second steel plates having aluminum-based plating films are heated to an austenite range temperature by first and second furnaces, respectively, to transform the bodies of the first and second steel plates into austenite and form Fe—Al alloy layers on the surfaces of the first and second steel plates. Hot press forming is then performed to the first and second steel plates formed with the Fe—Al alloy layers, the first and second steel plates being superposed. The first and second steel plates, which are hot press formed, are then welded.

### CROSS-REFERENCE TO RELATED APPLICATIONS

This application claims priority from Japanese Patent Application No. 2017-131343, filed Jul. 4, 2017, the content of which is incorporated herein by reference in its entirety.

### FILED OF THE INVENTION

The invention relates to a method of manufacturing a press formed product, particularly, to a method of manufacturing a press formed product which is partially reinforced with a reinforcement steel plate.

### BACKGROUND OF THE INVENTION

Conventionally, a press formed product which is formed of a base steel plate partially reinforced with a reinforcement steel plate is used in a vehicle structure for the safety of an occupant in an event of vehicle impact.

Japanese Patent Application Publication No. 2014-193712 describes a method of manufacturing a press formed product which is partially reinforced by forming a combined steel plate by superposing a reinforcement steel plate on a base steel plate in a region to be reinforced and spot-welding the superposed portion and by performing hot press forming to this combined steel plate.

Hot press forming is a press technique of heating a steel plate to an austenite range temperature at high temperature and pressing it with dies, in which the steel plate is quenched with the dies by rapid cooling effect, thereby largely enhancing the tensile strength of the steel plate.

Japanese Patent Application Publication No. 2016-124029 describes using a steel plate having an aluminum-based plating film as a member in order to prevent scale formation due to high temperature heating in hot press forming and enhance the corrosion resistance.

Applying a steel plate having an aluminum-based plating film described in Japanese Patent Application Publication No. 2016-124029 to a method of manufacturing a press formed product described in Japanese Patent Application Publication No. 2014-193712 provides a press formed product which is formed with a Fe—Al alloy layer on the surfaces of the steel plates in high temperature heating, having high corrosion resistance and being partially reinforced.

However, the heat capacity per unit area of the superposed portion of the base steel plate and the reinforcement steel plate is larger than an exposed portion of the base steel plate where the reinforcement steel plate is not superposed. Therefore, when the superposed portion is heated to a proper degree at high temperature in hot press forming, the exposed portion of the base steel plate with small heat capacity is heated to excess, thereby causing a problem of deformation in the layer structure of the Fe—Al alloy layer and degrading the weldability.

On the other hand, when the exposed portion of the base steel plate with small heat capacity is heated to a proper degree, heating the superposed portion is insufficient, thereby causing a problem of not forming the Fe—Al alloy layer to degrade the corrosion resistance and a problem of insufficiency in quenching by hot press forming.

Furthermore, there is also a problem that a steel plate shears near a spot welded portion due to sliding stress by hot press forming.

### SUMMARY OF THE INVENTION

To address the problems described above, a method of manufacturing a press formed product of the invention includes: heating first and second steel plates having aluminum-based plating films to an austenite range temperature, the first and second steel plates being not superposed, to transform bodies of the first and second steel plates into austenite and alloy the aluminum-based plating films so as to form Fe—Al alloy layers; performing hot press forming to the first and second steel plates formed with the Fe—Al alloy layers, the first and second steel plates being superposed without welded; and welding the first and second steel plates which are hot press formed.

### BRIEF DESCRIPTION OF THE DRAWINGS

FIG. 1 is a schematic diagram of a heating process of first and second steel plates.

FIG. 2 is a cross-sectional view of the first and second steel plates.

FIG. 3 is a perspective view showing a superposed state of the first and second steel plates.

FIG. 4A and FIG. 4B are cross-sectional views showing hot press forming.

FIG. 5 is a cross-sectional view of a press formed product.

FIG. 6 is a perspective view of the press formed product.

### DETAILED DESCRIPTION OF THE INVENTION

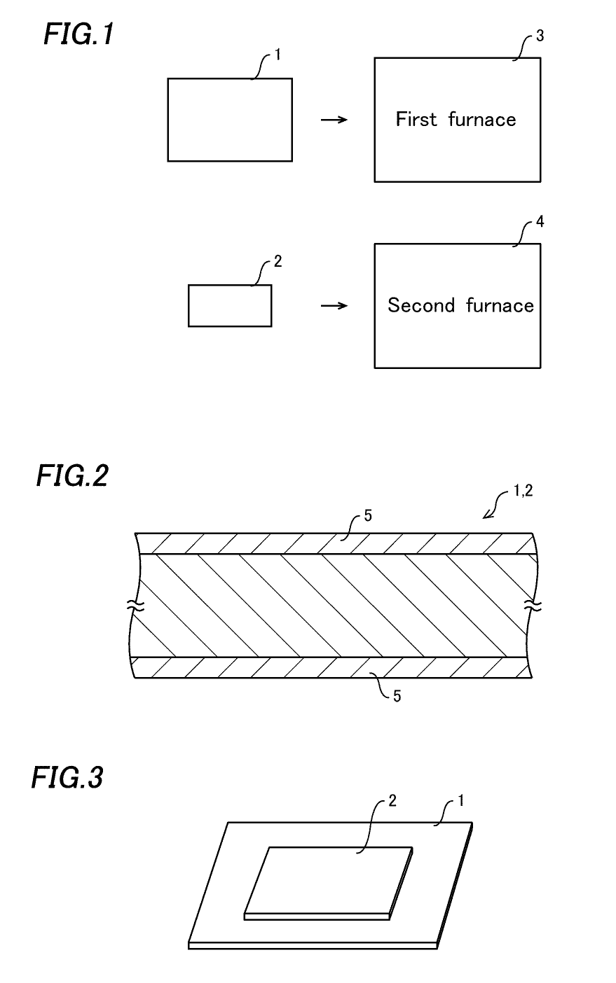

An embodiment of the invention will be described referring to figures. First, as shown in FIG. 1, first and second steel plates 1, 2 each having an aluminum-based plating film on the whole front and back surface are heated to an austenite range temperature TO by first and second furnaces 3, 4 respectively to transform the bodies of the first and second steel plates 1, 2 into austenite. The first steel plate 1 is a base steel plate, and the second steel plate 2 is a reinforcement steel plate.

At this time, as shown in FIG. 2, Al in the aluminum-based plating film and Fe in the first and second steel plates 1, 2 are alloyed to form a Fe—Al alloy layer 5 with high corrosion resistance on the whole front and back surfaces of the first and second steel plates 1, 2.

The austenite range temperature TO is, for example, about 900° C., although it differs depending on the carbon contents of the first and second steel plates 1, 2. The aluminum-based plating film is an aluminum plating film containing 10% Si, for example.

In the described heating process, it is preferable to obtain the Fe—Al alloy layer 5 having a five-layered structure by controlling the heating amounts of the first and second steel plates 1, 2 properly in order to obtain high weldability thereafter. From a Fe—Al—Si phase diagram, etc., this five-layered structure is supposed to contain Fe₂Al₅ in the first and third layers from the front surface, a mixed layer of Fe₂Al₅, FeAl, and Fe₃Si₂Al₃ in the second layer, FeAl in the fourth layer, and Al ferrite solid solution in the fifth layer. The five-layered structure is described for example, in an article, the Journal of the Japan Welding Society, pp. 23-30, no. 6, vol. 78 (2009).

As described, since the first and second steel plates 1, 2 are heated by the first and second furnaces 3, 4, respectively, without being superposed, the heating amounts are optimized to realize the transformation of the first and second steel plates 1, 2 into austenite, and the Fe—Al alloy layers 5 with high corrosion resistance and weldability are formed on the surfaces of these plates 1, 2.

When the heating amounts of the first and second steel plates 1, 2 are in excess, the layer structure of the Fe—Al alloy layer 5 turns to a two-layered structure instead of a five-layered structure, degrading the weldability. However, since the embodiment employs a process of heating the first and second steel plates 1, 2 which are not superposed, the heating amounts of the steel plates are respectively optimized to realize both the austenitizing of the steel plates and the formation of the Fe—Al alloy layers 5 having the five-layered structure. Furthermore, the first and second steel plates 1, 2 may be heated by one furnace as long as these are not superposed.

Next, the first and second steel plates 1, 2 are taken out from the first and second furnaces 3, 4 simultaneously, and the second steel plate 2 is superposed on the first steel plate 1 in a region to be reinforced, as shown in FIG. 3. In the embodiment, the whole second steel plate 2 is disposed within the area region of the first steel plate 1 in a planar view. These steel plates are not welded in this step.

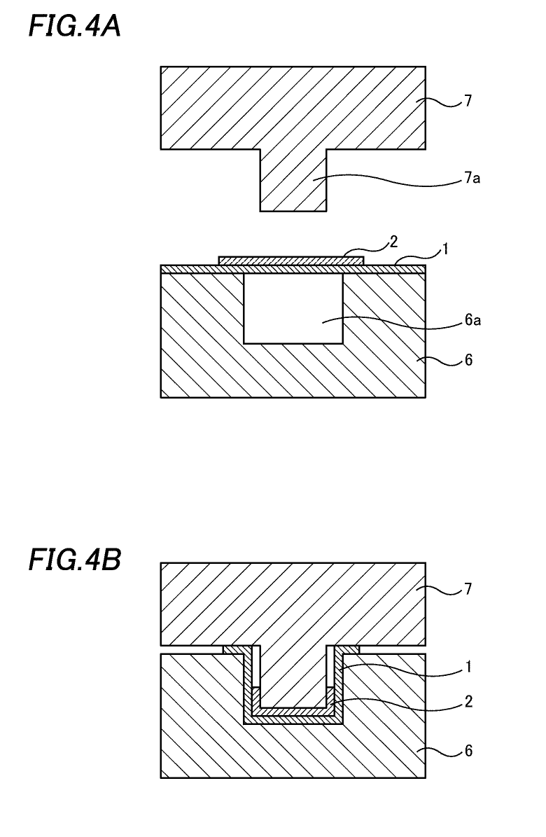

Then, as shown in FIG. 4A and FIG. 4B, hot press forming is performed to the first and second steel plates 1, 2 in the superposed state. As shown in the figures, a hot press forming machine is provided, which has an upper die 7 having a convex portion 7a disposed above a lower die 6 having a concave portion 6a, the convex portion 7a being to be engaged with the concave portion 6a. As shown in FIG. 4A, the first and second steel plates 1, 2 are set on the lower die 6, and the upper die 7 is moved downward to press the first and second steel plates 1, 2 between the lower die 6 and the upper die 7, thereby performing the rapid cooling and press forming of the first and second steel plates 1, 2 simultaneously, as shown in FIG. 4B.

Since the first and second steel plates 1, 2 are rapidly cooled from the austenite range temperature, martensite transformation occurs and quenching is achieved.

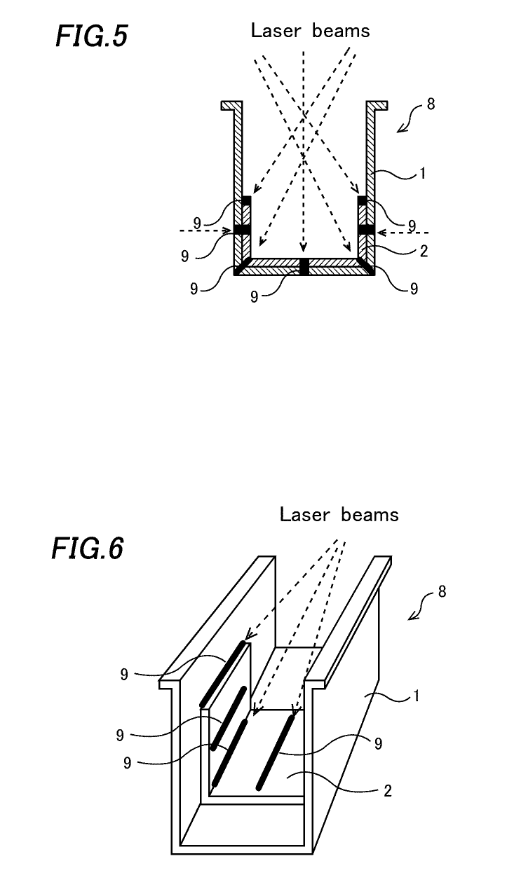

The dies are then opened, and a press formed product 8 shown in FIG. 5 and FIG. 6 is taken out. By this hot press forming, the first and second steel plates 1, 2 forming the press formed product 8 have highly enhanced tensile strengths of, for example, 1500 MPa, and the superposed portion of these is reinforced with the two steel plates of high tensile strengths.

The first steel plate 1 and second steel plate 2 forming the press formed product 8 are then welded. In this case, since the press formed product 8 often has a complex three-dimensional shape such as a U-shape cross-section, for example, it is preferable to use laser welding which has more flexibility in welding portions rather than spot welding.

In the case of laser welding, as shown in FIG. 5 and FIG. 6, for example, preferably, a laser beam shown by a broken line is applied to the bottom portion, the sidewalls, the bottom corner portions or the end portions of the press formed product 8 and beam scanning is performed as appropriate, thereby melting the first steel plate 1 and the second steel plate 2 partially and forming welded portions 9. In this case, the welding shape is not necessarily limited to the linear shape.

As described above, the manufacturing method of the embodiment enables manufacturing the partially reinforced press formed product 8 with high corrosion resistance and weldability. Furthermore, the first and second steel plates 1, 2 are superposed but not spot welded in hot press forming, and the welding is performed after the hot press forming. This prevents a problem that the steel plates shear near a welded portion due to sliding stress by hot press forming.

What is claimed is:

1. A method of manufacturing a press formed product, comprising:
heating first and second steel plates each having aluminum-based plating films to an austenite range temperature while the first and second steel plates are not superposed, to transform bodies of the first and second steel plates into austenite and alloy the aluminum-based plating films so as to form Fe—Al alloy layers;
performing hot press forming to the first and second steel plates on which the Fe—Al alloy layers are formed while the first and second steel plates are superposed but not welded; and
welding the first and second steel plates which are hot press formed.

2. The method of claim 1, wherein the first and second steel plates are heated by first and second furnaces, respectively.

3. The method of claim 1, wherein the welding comprises laser welding.
